(19) United States
(12) Patent Application Publication
(10) Pub. No.: US 2018/0077594 A1
(43) Pub. Date: Mar. 15, 2018

(54) METHOD FOR MEASURING AND REPORTING DATA TRANSMISSION DELAY, TERMINAL, AND STORAGE MEDIUM

(71) Applicant: ZTE CORPORATION, Guangdong (CN)

(72) Inventors: Meifang HE, Guangdong (CN); He HUANG, Guangdong (CN)

(73) Assignee: ZTE CORPORATION, Guangdong (CN)

(21) Appl. No.: 15/563,671

(22) PCT Filed: Mar. 3, 2016
(86) PCT No.: PCT/CN2016/075461

§ 371 Date: Oct. 2, 2017

(30) Foreign Application Priority Data
Apr. 1, 2015 (CN) 201510151365.9

(51) Int. Cl. H04W 24/10; H04L 12/26; H04W 24/08

(52) U.S. Cl. CPC H04W 24/10; H04W 24/02; H04W 24/08; H04L 43/0852

(57) ABSTRACT

A method for measuring and reporting a data transmission delay includes: receiving, by a terminal, delay measurement and reporting configuration information sent by a first network side; and measuring a data transmission delay between a first network and a second network according to the delay measurement and reporting configuration information, and reporting a measurement result to the first network side.

### CROSS REFERENCE

This application is the 371 application of PCT Application No. PCT/CN2016/075461 filed Mar. 3, 2016, which is based upon and claims priority to Chinese Patent Application No. 201510151365.9, filed on Apr. 1, 2015, the entire contents thereof are incorporated herein by reference.

### TECHNICAL FIELD

The present disclosure relates to the field of wireless communication technologies, and more particularly, to a method for measuring and reporting a data transmission delay, a terminal and a storage medium.

### BACKGROUND

With the development of wireless communication technologies, terminal data traffic takes on an expansive growth. To meet requirements of users for data transmission rate and traffic, some operators and companies have proposed to fuse a wireless local area network (WLAN) with the 3rd generation partnership project (3GPP) network to achieve an objective of load steering and improving network performance For this objective, 3GPP SA2 adopts an Access Network Discovery and Selection Functions (ANDSF) scheme, which is a WLAN interworking scheme based on a core network. However, in this scheme, no consideration is taken into the effect on the access network. In addition, the ANDSF is a relatively static scheme which cannot adapt well to dynamical variation of network load and channel quality. Next, in R12 WLAN/3GPP wireless interoperation, rules of executing WLAN steering and trigger mechanisms are introduced.

Compared with the existing strategy-and-trigger-dependent WLAN offload scheme which has been studied, the network integration of WLAN and 3GPP aggregated at a hierarchy of radio access network (RAN), hereinafter referred to as tightly-coupled WLAN and 3GPP networks, allows real-time and joint scheduling radio resources of WLAN and 3GPP networks, and thus improves quality of service (QoS) and the overall system capacity for users.

To prevent excessive delay of data transmission between the 3GPP network and the WLAN, a discard timer of packet data convergence protocol (PDCP) layer and PDCP status report feedback are used currently. When the PDCP layer receives each PDCP service data unit (SDU) from a higher layer, the discard timer is started. When this PDCP layer has not successfully transmitted the PDCP SDU until the timer expires, the terminal discards the PDCP SDU. When the PDCP status report determines that this PDCP SDU is transmitted successfully, the terminal still discards the PDCP SDU. However, to reduce data congestion and improve user experience, the 3GPP network still needs to learn data transmission delay between the 3GPP network and the WLAN. Therefore, how to provide a scheme of acquiring data transmission delay between access networks becomes a problem to be solved urgently.

This section provides background information related to the present disclosure which is not necessarily prior art.

### SUMMARY

On this account, embodiments of the present disclosure are expected to provide a method for measuring and reporting a data transmission delay, a terminal and a storage medium to reduce data congestion and enhance user experience.

To achieve the above objective, technical solutions of the embodiments the present disclosure are implemented as below.

An embodiment of the present disclosure provides a method for measuring and reporting a data transmission delay, which includes:

receiving, by a terminal, delay measurement and reporting configuration information sent by a first network side; and

measuring a data transmission delay between a first network and a second network according to the delay measurement and reporting configuration information, and reporting a measurement result to the first network side.

An embodiment of the present disclosure further provides a terminal, which includes: a receiving module and a processing module.

The receiving module is configured to receive delay measurement and reporting configuration information sent by a first network side.

The processing module is configure to measure a data transmission delay between a first network and a second network according to the delay measurement and reporting configuration information, and report a measurement result to the first network side.

An embodiment of the present disclosure further provides a terminal, including: a processor; and a memory configured to store instructions executable by the processor; wherein the processor is configured to perform: receiving delay measurement and reporting configuration information sent by a first network side; and measuring a data transmission delay between a first network and a second network according to the delay measurement and reporting configuration information, and reporting a measurement result to the first network side

An embodiment of the present disclosure further provides a computer storage medium, wherein the computer storage medium stores a computer program, and the computer program is configured to execute the method for measuring and reporting a data transmission delay according to the embodiment of the present disclosure.

According to the method for measuring and reporting a data transmission delay, the terminal and the storage medium provided by the embodiments of the present disclosure, the terminal receives delay measurement and reporting configuration information sent by a first network side, measures a data transmission delay between a first network and a second network according to the delay measurement and reporting configuration information, and reports a measurement result to the first network side. In this way, the first network side can timely learn the data transmission delay between the first network and the second network, so that the problem of delay can be better processed, thereby reducing time congestion and enhancing user experience.

This section provides a summary of various implementations or examples of the technology described in the disclosure, and is not a comprehensive disclosure of the full scope or all features of the disclosed technology.

### BRIEF DESCRIPTION OF THE DRAWINGS

In accompanying drawings (may be not drawn in scale), similar reference numerals may describe similar parts in different views. Similar reference numerals having different letter suffixes may denote different examples of similar parts. The accompanying drawings roughly show various embodiments discussed herein by way of examples instead of restriction manners.

FIG. 1 is a schematic diagram of a co-location applied to a WLAN and 3GPP integrated base station site;

FIG. 2 is a schematic diagram of a non-co-location applied to WLAN and 3GPP networks connecting to an ideal loop;

FIG. 3 is a schematic scenario diagram of a co-location solution applied to a small cell;

FIG. 4 is a schematic flowchart of a method for measuring and reporting a data transmission delay according to Embodiment I of the present disclosure;

FIG. 5 is a schematic flowchart of a method for measuring and reporting a data transmission delay according to Embodiment II of the present disclosure;

FIG. 6 is a schematic flowchart of a method for measuring and reporting a data transmission delay according to Embodiment III of the present disclosure;

FIG. 7 is a schematic flowchart of a method for measuring and reporting a data transmission delay according to Embodiment IV of the present disclosure;

FIG. 8 is a schematic flowchart of a method for measuring and reporting a data transmission delay according to Embodiment V of the present disclosure; and

FIG. 9 is a schematic structural diagram showing composition of a terminal according to an embodiment of the present disclosure.

### DETAILED DESCRIPTION

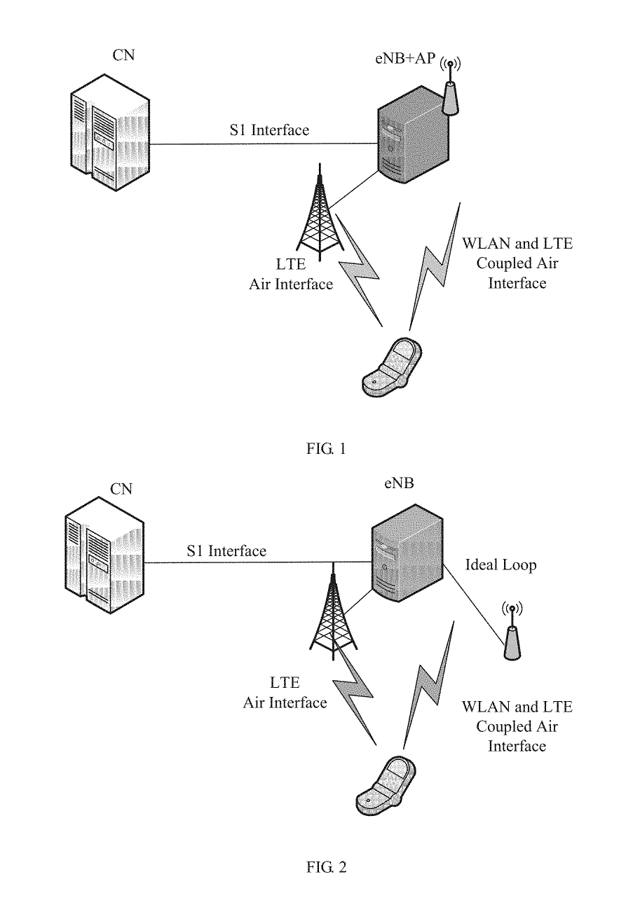

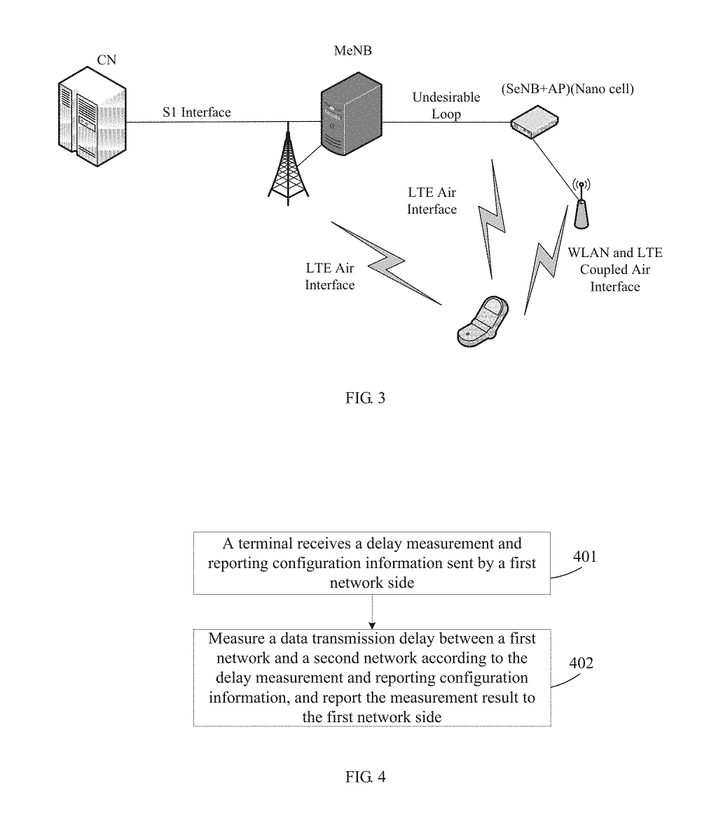

The WLAN and the 3GPP networks are closely coupled, similar to a carrier and a double linkage, and can be applied to a co-location scenario and a non-co-location scenario. The co-location scenario is a RAN layer integrated operation completed, via an internal interface, between an evolved node B (eNB) and an access point (AP) and is physically integrated, essentially similar to 3GPP carrier aggregation, and the scene generally is a small cell. The non-co-location scenario is a RAN layer integrated operation completed, via an external interface, between the eNB and the AP, and essentially is similar to a double linkage. FIG. 1 illustrates a schematic diagram of a co-location applied to a WLAN and 3GPP integrated base station site. FIG. 2 is a schematic diagram of a non-co-location applied to WLAN and 3GPP network connecting to an ideal loop. FIG. 3 is a schematic scenario diagram of a co-location solution applied to a small cell.

WLAN steering solutions tightly coupled with the WLAN and 3GPP networks include: simplified architecture PDCP layer steering, double linkage architecture PDCP layer steering, radio link control (RLC) layer steering, and media access control (MAC) layer steering.

In the simplified architecture PDCP layer steering, WLAN steering of downlink data stream is completed at a PDCP layer of the 3GPP access network, and then is transmitted to a PDCP adapter. The adapter completes a conversion from a protocol data unit (PDU) of the PDCP of the 3GPP to a PDU of a MAC of the WLAN. The WLAN steering of downlink data stream is transmitted to a MAC layer of the WLAN via a radio air interface of the WLAN, and then is transmitted to the PDCP adapter of the terminal. The adapter of the terminal completes the conversion from the MAC protocol data unit of the WLAN to the protocol data unit of the PDCP, then transmits the downlink data stream to a PDCP entity of a UE, and finally, the PDCP entity transmits a service data unit of the PDCP to a corresponding application service. The uplink data stream is transmitted from the PDCP entity of the terminal to the PDCP entity of the 3GPP access network. The transmission process is similar to the downlink transmission process, and just the direction is opposite.

In the double linkage architecture PDCP layer steering, the data are steered twice. First, the data stream is distributed, by the PDCP layer of the 3GPP access network, to a radio link control layer of a small cell of a secondary base station, then downlink data stream is steered for the second time in the MAC of the small cell, namely, WLAN is steered to the MAC adapter. The adapter completes the conversion from the MAC protocol data unit of the 3GPP to the MAC protocol data unit of the WLAN, then transmits the data stream to a MAC layer of the WLAN of the terminal via a radio air interface of the WLAN, then transmits the data stream to a MAC adapter of the terminal to complete conversion from the MAC protocol data unit of the WLAN to the protocol data unit of the MAC, and then transmits the data stream to a MAC entity of a UE, and finally transmits the data stream to a corresponding application service according to a 3GPP air interface protocol. The transmission process of the uplink data stream is similar to the downlink transmission process, and just the direction is opposite.

In the RLC layer streaming, WLAN steering of downlink data stream is completed at an RLC layer of the 3GPP access network, and then is transmitted to an RLC adapter. The adapter completes a conversion from a protocol data unit of the RLC of the 3GPP to a protocol data unit of the MAC of the WLAN. The WLAN steering of downlink data stream is transmitted to a MAC layer of the WLAN via a radio air interface of the WLAN, and then is transmitted to the RLC adapter of the terminal. The RLC adapter of the terminal completes a conversion from the MAC protocol data unit of the WLAN to the protocol data unit of the RLC, then transmits the downlink data stream to a PDCP entity of a UE, and finally the PDCP entity transmits a service data unit of the PDCP to a corresponding application service. The uplink data stream is transmitted from a PDCP entity of the terminal to a PDCP entity of the 3GPP access network, the transmission process thereof is similar to the downlink transmission process, and just the direction is opposite.

In the MAC layer steering, WLAN steering of downlink data stream is completed at a MAC layer of the 3GPP access network, and then is transmitted to a MAC adapter. The adapter completes a conversion from a protocol data unit of the MAC of the 3GPP to a MAC protocol data unit of the WLAN. The downlink data stream is transmitted to a MAC layer of the WLAN via a radio air interface of the WLAN, and then is transmitted to the MAC adapter of the terminal. The MAC adapter of the terminal completes a conversion from the MAC protocol data unit of the WLAN to the protocol data unit of the MAC, then transmits the downlink data stream to a PDCP entity of a UE, and finally, the PDCP entity transmits a service data unit of the PDCP to a corresponding application service. The uplink data stream is transmitted from the PDCP entity of the terminal to the PDCP entity of the 3GPP access network. The transmission process is similar to the downlink transmission process, and just the direction is opposite.

In the embodiment of the present disclosure, the terminal receives delay measurement and reporting configuration information sent by a first network side, measures a data transmission delay between a first network and a second network according to the delay measurement and reporting configuration information, and reports a measurement result to the first network side.

### Embodiment I

FIG. 4 illustrates a schematic flowchart of a method for measuring and reporting a data transmission delay according to Embodiment I of the present disclosure. As shown in FIG. 4, the method for measuring and reporting a data transmission delay according to the embodiment of the present disclosure includes following steps.

In Step 401, a terminal receives delay measurement and reporting configuration information sent by a first network side.

In the embodiment of the present disclosure, the first network may be a 3GPP access network, which is not only applicable to a long term evolution (LTE) system but also applicable to a universal mobile telecommunications system (UMTS).

This step includes: receiving, by the terminal via a radio resource control (RRC) signaling, the delay measurement and reporting configuration information sent by the first network side; or

receiving, via packet data convergence protocol (PDCP) control information, the delay measurement and reporting configuration information sent by the first network side; or

receiving, via RLC control information, the delay measurement and reporting configuration information sent by the first network side; or

receiving, via MAC control information, the delay measurement and reporting configuration information sent by the first network side; or

receiving, via second network adaptation layer control information, the delay measurement and reporting configuration information sent by the first network side.

The second network herein may be a WLAN network.

In an embodiment, the delay measurement and reporting configuration information includes one or more of:

a delay measurement starting condition, a delay measurement stopping condition, a delay reporting type, a delay reporting triggering condition, a logic channel required for delay measurement, and a second network type required for delay measurement.

The delay measurement starting condition may refer to receiving delay measurement and reporting configuration information sent by the first network side.

The delay measurement stopping condition may refer to a preset measurement timer overtime. Correspondingly, after the terminal receives the delay measurement and reporting configuration information sent by the first network side, the method further includes: starting, by the terminal, the preset measurement timer.

The delay reporting type includes: periodical reporting, event triggering reporting and so on.

When the delay reporting type is the event triggering reporting, the delay reporting triggering condition may be one or more of:

an average delay of data transmission between the first network and the second network within a period of time exceeding a preset first threshold, a proportion of packets whose delay exceeds a preset delay threshold within a period of time exceeding a preset second threshold, a proportion of the number of data bits whose delay exceeds a preset delay threshold within a period of time exceeding a preset third threshold, an average delay of data transmission between the first network and the second network within a period of time being below a preset fourth threshold, a proportion of packets whose delay exceeds a preset delay threshold within a period of time being below a preset fifth threshold, and a proportion of the number of data bits whose delay exceeds a preset delay threshold within a period of time being below a preset sixth threshold.

The first threshold to the sixth threshold herein may be set according to specific circumstances. The period of time may be set according to actual situations, which may be equal to or smaller than the measurement time, or may be appointed by a protocol, or may be configured in the delay measurement and reporting configuration information. The measurement time is time between starting the measurement timer and the measurement timer overtime.

When the delay reporting type is the periodical reporting, the delay measurement and reporting configuration information may further include a measurement period. The delay reporting triggering condition refers to timer periodical triggering. That is, the measurement result is reported when the preset measurement timer is overtime, then the timer is reset to zero and restarts timing and delay measurement, and the measurement result is reported when the measurement timer is overtime again.

In an embodiment, when the delay reporting type is the periodical reporting, the measurement timer starting condition or stopping condition may be one or more of:

an average delay of data transmission between the first network and the second network within a period of time exceeding a preset first threshold, a proportion of packets whose delay exceeds a preset delay threshold within a period of time exceeding a preset second threshold, a proportion of the number of data bits whose delay exceeds a preset delay threshold within a period of time exceeding a preset third threshold, an average delay of data transmission between the first network and the second network within a period of time being below a preset fourth threshold, a proportion of packets whose delay exceeds a preset delay threshold within a period of time being below a preset fifth threshold, and a proportion of the number of data bits whose delay exceeds a preset delay threshold within a period of time being below a preset sixth threshold.

Herein, when the delay reporting type is the periodical reporting, the period of time may be measurement time, the length of which may be set according to actual circumstances.

The second network required for delay measurement may be a WLAN access network.

In an embodiment, after this step, the method further includes:

saving, by the terminal, the delay measurement and reporting configuration information.

In Step 402, a data transmission delay between a first network and a second network is measured according to the delay measurement and reporting configuration information, and a measurement result is reported to the first network side.

Herein, the measuring a data transmission delay between a first network and a second network according to the delay measurement and reporting configuration information includes:

decoding a packet transmitted in the second network according to the delay measurement and reporting configuration information to obtain a first timestamp packaged at the first network side and acquire a second timestamp of a current first network serving cell, and calculating a differential between the first timestamp and the second timestamp and determining the differential as a transmission delay of the packet; herein acquiring the first timestamp and the second timestamp does not have specific sequences, that is, either the first timestamp or the second timestamp may be acquired first; and

acquiring transmission delays of a plurality of packets transmitted in the second network within measurement time and calculating an average value of the transmission delays, the average value of the transmission delays being an average delay of data transmission between the first network and the second network within the measurement time.

Herein, the packet is a protocol data unit (PDU). When a service data unit (SDU) of the terminal is packaged into the packet at the first network side, current first network system time (namely, the first timestamp) is added into the packet header. Correspondingly, the first timestamp is obtained when the terminal decodes the packet to obtain the SDU.

In an embodiment, the measurement result includes one or more of: an average delay of data transmission between the first network and the second network within a period of time, a proportion of packets whose delay exceeds a preset delay threshold within a period of time, a proportion of the number of data bits whose delay exceeds a preset delay threshold within a period of time, a maximum value of data transmission delay between the first network and the second network within a period of time, and a real-time data transmission delay between the first network and the second network.

Herein the period of time may be set according to actual circumstances, which may be equal to or smaller than the measurement time.

When the period of time is equal to the measurement time, the average delay of data transmission between the first network and the second network within the period of time is the average value of the transmission delays of a plurality of packets transmitted in the second network within the measurement time.

When the period of time is equal to the measurement time, the proportion of packets whose delay exceeds a preset delay threshold within the period of time is a ratio of the number of packets whose transmission delay in the second network within the measurement time exceeds the preset delay threshold to the total number of packets transmitted in the second network within the measurement time.

When the period of time is equal to the measurement time, the proportion of the number of data bits whose delay exceeds a preset delay threshold within the period of time is a ratio of the number of data bits whose transmission delay in the second network exceeds the preset delay threshold within the measurement time to the total number of data bits transmitted in the second network within the measurement time.

When the period of time is equal to the measurement time, the maximum value of data transmission delay between the first network and the second network within the period of time is the maximum value of the transmission delays of a plurality of packets transmitted in the second network within the measurement time.

The real-time data transmission delay between the first network and the second network is the transmission delay of the packet transmitted in the second network obtained based on real-time measurement.

In an embodiment, the reporting the measurement result to the first network side includes:

reporting, by the terminal, the measurement result to the first network side via the RRC signaling; or

reporting the measurement result to the first network side via the PDCP layer control information; or

reporting the measurement result to the first network side via the RLC layer control information; or

reporting the measurement result to the first network side via the MAC layer control information; or

reporting the measurement result to the first network side via the second network adaptation layer.

In an embodiment, granularity of the measurement and reporting may be a combination of one or more of a single logic channel, the whole second network, the terminal, and a carrier/serving cell.

When the granularity of the measurement and reporting is the single logic channel, the measurement and reporting refer to measuring and reporting the transmission delay of the packet transmitted on each logic channel

When the granularity of the measurement and reporting is the whole second network, the measurement and reporting refer to measuring and reporting the transmission delays of all the packets transmitted in the whole second network.

When the granularity of the measurement and reporting is the terminal, the measurement and reporting refer to measuring and reporting the transmission delay of a packet transmitted by a certain terminal, herein the terminal may be a user equipment (UE).

When the granularity of the measurement and reporting is the carrier or serving cell, the measurement and reporting refer to measuring and reporting the transmission delay of a packet transmitted on the specific carrier or serving cell.

In an embodiment, when the delay reporting type is the periodical reporting, the terminal not only may immediately perform the measurement and reporting after receiving the delay measurement and reporting configuration information, but also may perform the measurement and reporting when the measurement timer is reset to zero and starts timing after receiving the delay measurement and reporting configuration information.

In an embodiment, when the delay reporting type is the event triggering reporting, the measurement result sent by the terminal to the first network side is higher in priority than ordinary user plane data.

In an embodiment, when the delay reporting triggering condition is unsatisfied, namely when the currently configured event is not triggered or a configured periodical reporting period is not reached but the ordinary user plane data are less than the currently transportable data size, the terminal utilizes the residual bits to transmit the measurement result information.

It is to be noted that in the embodiment of the present disclosure, the first network and the second network may be different networks or may be the same network. For example, the first network and the second network may be an LTE network.

### Embodiment II

FIG. 5 illustrates a schematic flowchart of a method for measuring and reporting a data transmission delay according to Embodiment II of the present disclosure. In the embodiment of the present disclosure, the first network is a 3GPP access network, the second network is a WLAN network, and a simplified architecture PDCP layer steering is taken as an application scenario. As shown in FIG. 5, the method for measuring and reporting a data transmission delay according to the embodiment of the present disclosure includes following steps.

In Step 501, the terminal receives, via PDCP control information, the delay measurement and reporting configuration information sent by the 3GPP access network and saves the same.

Herein, a PDCP entity of the terminal receives, via PDCP control information, the delay measurement and reporting configuration information sent by a PDCP entity of a primary base station of the 3GPP access network.

The format of the PDCP control information is:

a data/control domain is partly configured as a control domain;

the type of the protocol data unit is delay measurement; and

one or more of a delay measurement starting condition, a delay measurement stopping condition, a delay reporting type, a delay reporting triggering condition, and a logic channel required for delay measurement of the delay measurement and reporting configuration information.

The delay measurement starting condition may refer to receiving the delay measurement and reporting configuration information sent by the 3GPP access network. That is, delay measurement is started after receiving the delay measurement and reporting configuration information sent by the 3GPP access network.

The delay measurement stopping condition may refer to a preset measurement timer overtime. Correspondingly, after the terminal receives the delay measurement and reporting configuration information sent by the 3GPP access network, the method further includes: starting, by the terminal, the preset measurement timer.

In the embodiment of the present disclosure, the delay reporting type is periodical reporting.

Correspondingly, the delay measurement and reporting configuration information further includes a measurement period. The delay reporting triggering condition refers to a preset measurement timer overtime. That is, the measurement result is reported when the measurement timer is overtime, then the timer is reset to zero and restarts timing and delay measurement, and the measurement result is reported when the measurement timer is overtime again.

In an embodiment, the measurement timer starting condition/stopping condition also may be one or more of:

an average delay of data transmission between the 3GPP access network and the WLAN network within a period of time exceeding a preset first threshold, a proportion of packets whose delay exceeds a preset delay threshold within a period of time exceeding a preset second threshold, a proportion of the number of data bits whose delay exceeds a preset delay threshold within a period of time exceeding a preset third threshold, an average delay of data transmission between the 3GPP access network and the WLAN network within a period of time being below a preset fourth threshold, a proportion of packets whose delay exceeds a preset delay threshold within a period of time being below a preset fifth threshold, and a proportion of the number of data bits whose delay exceeds a preset delay threshold within a period of time being below a preset sixth threshold. That is, the measurement timer may be started or stopped when one or more of the above conditions are satisfied.

Herein, when the delay reporting type is the periodical reporting, the period of time may be measurement time, the length of which may be set according to actual circumstances.

In Step 502: a data transmission delay between the 3GPP access network and the WLAN network is measured according to the delay measurement and reporting configuration information, and the measurement result is reported to the 3GPP access network via the PDCP control information.

Herein, the measuring a data transmission delay between the 3GPP access network and the WLAN network according to the delay measurement and reporting configuration information includes:

decoding a packet transmitted in the WLAN network according to the delay measurement and reporting configuration information to obtain a first timestamp packaged at the 3GPP access network and acquire a second timestamp of a current serving cell, and calculating a differential between the first timestamp and the second timestamp and determining the differential as a transmission delay of the packet; and

acquiring transmission delays of a plurality of packets transmitted in the WLAN network within measurement time and calculating an average value of the transmission delays, the average value of the transmission delays being an average delay of data transmission between the 3GPP access network and the WLAN network within the measurement time.

Herein, the packet is a protocol data unit (PDU). When a service data unit (SDU) of the terminal is packaged into the packet at the 3GPP access network, current 3GPP access network system time (namely, the first timestamp) is added into the packet header. Correspondingly, the first timestamp is obtained when the terminal decodes the packet to obtain the SDU.

In an embodiment, the measurement result includes one or more of: an average delay of data transmission between the 3GPP access network and the WLAN network within measurement time, a proportion of packets whose delay exceeds a preset delay threshold within measurement time, a proportion of the number of data bits whose delay exceeds a preset delay threshold within measurement time, a maximum value of data transmission delay between the 3GPP access network and the WLAN network within measurement time, and a real-time data transmission delay between the 3GPP access network and the WLAN network.

In an embodiment, granularity of the measurement and reporting may be a combination of one or more of a single logic channel, the whole WLAN network, the terminal, and a carrier/serving cell.

When the granularity of the measurement and reporting is the single logic channel, the measurement and reporting refer to measuring and reporting the transmission delay of the packet transmitted on each logic channel

When the granularity of the measurement and reporting is the whole WLAN network, the measurement and reporting refer to measuring and reporting the transmission delays of all the packets transmitted in the whole WLAN network.

When the granularity of the measurement and reporting is the terminal, the measurement and reporting refer to measuring and reporting the transmission delay of a packet transmitted by a certain terminal, herein the terminal may be a user equipment (UE).

When the granularity of the measurement and reporting is the carrier or serving cell, the measurement and reporting refer to measuring and reporting the transmission delay of a packet transmitted on the specific carrier or serving cell.

In an embodiment, when the delay reporting triggering condition is unsatisfied, namely when the currently configured periodical reporting is not reached but the ordinary user plane data are less than the currently transportable data size, the terminal utilizes the residual bits to transmit the measurement result information.

### Embodiment III

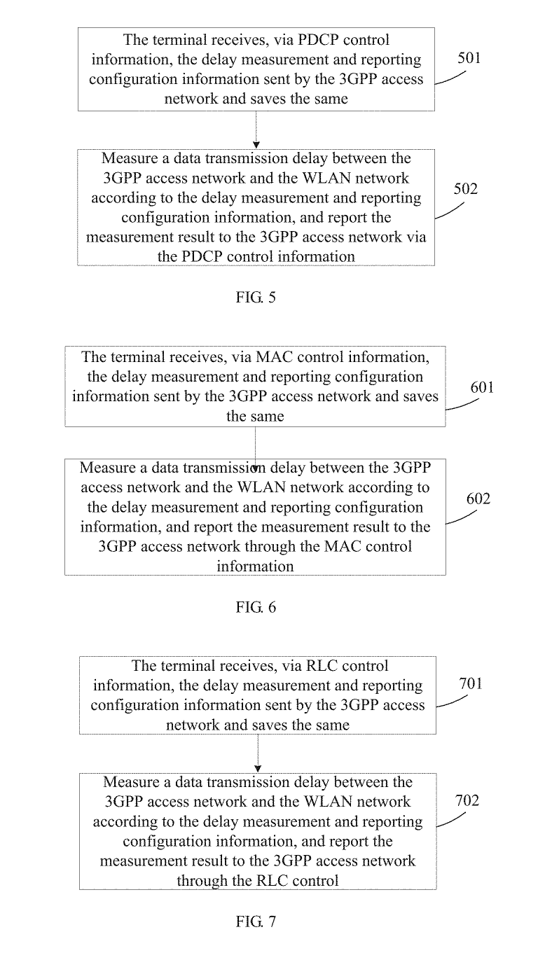

FIG. 6 illustrates a schematic flowchart of a method for measuring and reporting a data transmission delay according to Embodiment III of the present disclosure. In the embodiment of the present disclosure, the first network is a 3GPP access network, the second network is a WLAN network, and a MAC layer steering is taken as an application scenario. As shown in FIG. 6, the method for measuring and reporting a data transmission delay according to the embodiment of the present disclosure includes following steps.

In Step 601, the terminal receives, via MAC control information, the delay measurement and reporting configuration information sent by the 3GPP access network and saves the same.

Herein, a MAC entity of the terminal receives, via the MAC control information, the delay measurement and reporting configuration information sent by a MAC entity of a primary base station of the 3GPP access network.

The format of the MAC control information is:

a data/control domain is partly configured as a control domain;

the type of the protocol data unit is delay measurement; and

one or more of a delay measurement starting condition, a delay measurement stopping condition, a delay reporting type, a delay reporting triggering condition, and a logic channel required for delay measurement of the delay measurement and reporting configuration information.

The delay measurement starting condition may refer to receiving the delay measurement and reporting configuration information sent by the 3GPP access network. That is, delay measurement is started after receiving the delay measurement and reporting configuration information sent by the 3GPP access network.

The delay measurement stopping condition may refer to a preset measurement timer overtime. Correspondingly, after the terminal receives the delay measurement and reporting configuration information sent by the 3GPP access network, the method further includes: starting, by the terminal, the preset measurement timer.

In the embodiment of the present disclosure, the delay reporting type is the event triggering reporting.

The delay reporting triggering condition may be one or more of:

an average delay of data transmission between the 3GPP access network and the WLAN network within a period of time exceeding a preset first threshold, a proportion of packets whose delay exceeds a preset delay threshold within a period of time exceeding a preset second threshold, a proportion of the number of data bits whose delay exceeds a preset delay threshold within a period of time exceeding a preset third threshold, an average delay of data transmission between the 3GPP access network and the WLAN network within a period of time being below a preset fourth threshold, a proportion of packets whose delay exceeds a preset delay threshold within a period of time being below a preset fifth threshold, and a proportion of the number of data bits whose delay exceeds a preset delay threshold within a period of time being below a preset sixth threshold.

Herein, the period of time may be set according to actual situations, which may be equal to or smaller than the measurement time, or may be appointed by a protocol, or may be configured in the MAC control information. The measurement time is time between starting the measurement timer and the measurement timer overtime.

In Step 602, a data transmission delay between the 3GPP access network and the WLAN network is measured according to the delay measurement and reporting configuration information, and the measurement result is reported to the 3GPP access network through the MAC control information.

Herein, the measuring a data transmission delay between the 3GPP access network and the WLAN network according to the delay measurement and reporting configuration information includes:

decoding a packet transmitted in the WLAN network according to the delay measurement and reporting configuration information to obtain a first timestamp packaged at the 3GPP access network and acquire a second timestamp of a current serving cell, and calculating a differential between the first timestamp and the second timestamp and determining the differential as a transmission delay of the packet; and acquiring transmission delays of a plurality of packets transmitted in the WLAN network within measurement time and calculating an average value of the transmission delays, wherein the average value of the transmission delays is the delay of data transmission between the 3GPP access network and the WLAN network within the measurement time.

Herein, the packet is a protocol data unit (PDU). When a service data unit (SDU) of the terminal is packaged into the packet at the 3GPP access network, current 3GPP access network system time (namely, the first timestamp) is added into the packet header. Correspondingly, the first timestamp is obtained when the terminal decodes the packet to obtain the SDU.

In an embodiment, the measurement result includes one or more of: an average delay of data transmission between the 3GPP access network and the WLAN network within measurement time, a proportion of packets whose delay exceeds a preset delay threshold within measurement time, a proportion of the number of data bits whose delay exceeds a preset delay threshold within measurement time, a maximum value of data transmission delay between the 3GPP access network and the WLAN network within measurement time, and a real-time data transmission delay between the 3GPP access network and the WLAN network.

In an embodiment, granularity of the measurement and reporting may be a combination of one or more of a single logic channel, the whole WLAN network, the terminal, and a carrier/serving cell.

When the granularity of the measurement and reporting is the single logic channel, the measurement and reporting refer to measuring and reporting the transmission delay of the packet transmitted on each logic channel

When the granularity of the measurement and reporting is the whole WLAN network, the measurement and reporting refer to measuring and reporting the transmission delays of all the packets transmitted in the whole second network.

When the granularity of the measurement and reporting is the terminal, the measurement and reporting refer to measuring and reporting the transmission delay of a packet transmitted by a certain terminal, herein the terminal may be a user equipment (UE).

When the granularity of the measurement and reporting is the carrier or serving cell, the measurement and reporting refer to measuring and reporting the transmission delay of a packet transmitted on the specific carrier or serving cell.

In an embodiment, in the embodiment of the present disclosure, the measurement result sent by the terminal to the 3GPP access network is higher in priority than ordinary user plane data.

In an embodiment, when the delay reporting triggering condition is unsatisfied but the ordinary user plane data are less than the currently transportable data size, the terminal utilizes the residual bits to transmit the measurement result information.

### Embodiment IV

FIG. 7 illustrates a schematic flowchart of a method for measuring and reporting a data transmission delay according to Embodiment IV of the present disclosure. In the embodiment of the present disclosure, the first network is a 3GPP access network, the second network is a WLAN network, and a simplified architecture RLC layer steering is taken as an application scenario. As shown in FIG. 7, the method for measuring and reporting a data transmission delay according to the embodiment of the present disclosure includes following steps.

In Step 701, the terminal receives, via RLC control information, the delay measurement and reporting configuration information sent by the 3GPP access network and saves the same.

Herein, an RLC entity of the terminal receives, via the RLC control information, the delay measurement and reporting configuration information sent by an RLC entity of a primary base station of the 3GPP access network.

The format of the RLC control information is:

a data/control domain is partly configured as a control domain;

the type of the protocol data unit is delay measurement; and

one or more of a delay measurement starting condition, a delay measurement stopping condition, a delay reporting type, a delay reporting triggering condition, and a logic channel required for delay measurement of the delay measurement and reporting configuration information.

The delay measurement starting condition may refer to receiving the delay measurement and reporting configuration information sent by the 3GPP access network. That is, delay measurement is started after receiving the delay measurement and reporting configuration information sent by the 3GPP access network.

The delay measurement stopping condition may refer to a preset measurement timer overtime. Correspondingly, after the terminal receives the delay measurement and reporting configuration information sent by the 3GPP access network, the method further includes: starting, by the terminal, the preset measurement timer.

In the embodiment of the present disclosure, the delay reporting type is periodical reporting.

Correspondingly, the delay measurement and reporting configuration information further includes a measurement period. The delay reporting triggering condition refers to a preset measurement timer overtime. That is, the measurement result is reported when the measurement timer is overtime, then the timer is reset to zero and restarts timing and delay measurement, and the measurement result is reported when the measurement timer is overtime again.

In an embodiment, the measurement timer starting condition/stopping condition also may be one or more of:

an average delay of data transmission between the 3GPP access network and the WLAN network within a period of time exceeding a preset first threshold, a proportion of packets whose delay exceeds a preset delay threshold within a period of time exceeding a preset second threshold, a proportion of the number of data bits whose delay exceeds a preset delay threshold within a period of time exceeding a preset third threshold, an average delay of data transmission between the 3GPP access network and the WLAN network within a period of time being below a preset fourth threshold, a proportion of packets whose delay exceeds a preset delay threshold within a period of time being below a preset fifth threshold, and a proportion of the number of data bits whose delay exceeds a preset delay threshold within a period of time being below a preset sixth threshold. That is, the measurement timer may be started or stopped when one or more of the above conditions are satisfied.

Herein, when the delay reporting type is the periodical reporting, the period of time may be measurement time, the length of which may be set according to actual circumstances.

In Step 702, a data transmission delay between the 3GPP access network and the WLAN network is measured according to the delay measurement and reporting configuration information, and the measurement result is reported to the 3GPP access network through the RLC control information.

Herein, the measuring a data transmission delay between the 3GPP access network and the WLAN network according to the delay measurement and reporting configuration information includes:

decoding a packet transmitted in the WLAN network according to the delay measurement and reporting configuration information to obtain a first timestamp packaged at the 3GPP access network and acquire a second timestamp of a current serving cell, and calculating a differential between the first timestamp and the second timestamp and determining the differential as a transmission delay of the packet; and acquiring transmission delays of a plurality of packets transmitted in the WLAN network within measurement time and calculating an average value of the transmission delays, wherein the average value of the transmission delays is the delay of data transmission between the 3GPP access network and the WLAN network within the measurement time.

Herein, the packet is a protocol data unit (PDU). When a service data unit (SDU) of the terminal is packaged into the packet at the 3GPP access network, current 3GPP access network system time (namely, the first timestamp) is added into the packet header. Correspondingly, the first timestamp is obtained when the terminal decodes the packet to obtain the SDU.

In an embodiment, the measurement result includes one or more of: an average delay of data transmission between the 3GPP access network and the WLAN network within measurement time, a proportion of packets whose delay exceeds a preset delay threshold within measurement time, a proportion of the number of data bits whose delay exceeds a preset delay threshold within measurement time, a maximum value of data transmission delay between the 3GPP access network and the WLAN network within measurement time, and a real-time data transmission delay between the 3GPP access network and the WLAN network.

In an embodiment, granularity of the measurement and reporting may be a combination of one or more of a single logic channel, the whole WLAN network, the terminal, and a carrier/serving cell.

When the granularity of the measurement and reporting is the single logic channel, the measurement and reporting refer to measuring and reporting the transmission delay of the packet transmitted on each logic channel

When the granularity of the measurement and reporting is the whole WLAN network, the measurement and reporting refer to measuring and reporting the transmission delays of all the packets transmitted in the whole second network.

When the granularity of the measurement and reporting is the terminal, the measurement and reporting refer to measuring and reporting the transmission delay of a packet transmitted by a certain terminal, herein the terminal may be a user equipment (UE).

When the granularity of the measurement and reporting is the carrier or serving cell, the measurement and reporting refer to measuring and reporting the transmission delay of a packet transmitted on the specific carrier or serving cell.

In an embodiment, when the delay reporting triggering condition is unsatisfied, namely when the currently configured periodical reporting is not reached but the ordinary user plane data are less than the currently transportable data size, the terminal utilizes the residual bits to transmit the measurement result information.

### Embodiment V

FIG. 8 illustrates a schematic flowchart of a method for measuring and reporting a data transmission delay according to Embodiment V of the present disclosure. In the embodiment of the present disclosure, the first network is a 3GPP access network, the second network is a WLAN network, and an RLC layer steering is taken as an application scenario. As shown in FIG. 8, the method for measuring and reporting a data transmission delay according to the embodiment of the present disclosure includes following steps.

In Step 801, the terminal receives, via RLC adapter control information, the delay measurement and reporting configuration information sent by the 3GPP access network and saves the same.

Herein, the RLC adapter of the terminal receives, via the RLC adapter control information, the delay measurement and reporting configuration information sent by an RLC adapter of a primary base station of the 3GPP access network.

The format of the RLC adapter control information is:

a data/control domain is partly configured as a control domain;

the type of the protocol data unit is delay measurement; and

one or more of a delay measurement starting condition, a delay measurement stopping condition, a delay reporting type, a delay reporting triggering condition, and a logic channel required for delay measurement of the delay measurement and reporting configuration information.

The delay measurement starting condition may refer to receiving the delay measurement and reporting configuration information sent by the 3GPP access network. That is, delay measurement is started after receiving the delay measurement and reporting configuration information sent by the 3GPP access network.

The delay measurement stopping condition may refer to a preset measurement timer overtime. Correspondingly, after the terminal receives the delay measurement and reporting configuration information sent by the 3GPP access network, the method further includes: starting, by the terminal, the preset measurement timer.

In the embodiment of the present disclosure, the delay reporting type is the event triggering reporting.

The delay reporting triggering condition may be one or more of:

an average delay of data transmission between the 3GPP access network and the WLAN network within a period of time exceeding a preset first threshold, a proportion of packets whose delay exceeds a preset delay threshold within a period of time exceeding a preset second threshold, a proportion of the number of data bits whose delay exceeds a preset delay threshold within a period of time exceeding a preset third threshold, an average delay of data transmission between the 3GPP access network and the WLAN network within a period of time being below a preset fourth threshold, a proportion of packets whose delay exceeds a preset delay threshold within a period of time being below a preset fifth threshold, and a proportion of the number of data bits whose delay exceeds a preset delay threshold within a period of time being below a preset sixth threshold.

Herein, the period of time may be set according to actual situations, which may be equal to or smaller than the measurement time, or may be appointed by a protocol, or may be configured in the RLC adapter control information. The measurement time is time between starting the measurement timer and the measurement timer overtime.

In Step 802, a data transmission delay between the 3GPP access network and the WLAN network is measured according to the delay measurement and reporting configuration information, and the measurement result is reported to the 3GPP access network through the RLC adapter control information.

Herein, the measuring a data transmission delay between the 3GPP access network and the WLAN network according to the delay measurement and reporting configuration information includes:

decoding a packet transmitted in the WLAN network according to the delay measurement and reporting configuration information to obtain a first timestamp packaged at the 3GPP access network and acquire a second timestamp of a current serving cell, and calculating a differential between the first timestamp and the second timestamp and determining the differential as a transmission delay of the packet; and acquiring transmission delays of a plurality of packets transmitted in the WLAN network within measurement time and calculating an average value of the transmission delays, wherein the average value of the transmission delays is the delay of data transmission between the 3GPP access network and the WLAN network within the measurement time.

Herein, the packet is a protocol data unit (PDU). When a service data unit (SDU) of the terminal is packaged into the packet at the 3GPP access network, current 3GPP access network system time (namely, the first timestamp) is added into the packet header. Correspondingly, the first timestamp is obtained when the terminal decodes the packet to obtain the SDU.

In an embodiment, the measurement result includes one or more of: an average delay of data transmission between the 3GPP access network and the WLAN network within measurement time, a proportion of packets whose delay exceeds a preset delay threshold within measurement time, a proportion of the number of data bits whose delay exceeds a preset delay threshold within measurement time, a maximum value of data transmission delay between the 3GPP access network and the WLAN network within measurement time, and a real-time data transmission delay between the 3GPP access network and the WLAN network.

In an embodiment, granularity of the measurement and reporting may be a combination of one or more of a single logic channel, the whole WLAN network, the terminal, and a carrier/serving cell.

When the granularity of the measurement and reporting is the single logic channel, the measurement and reporting refer to measuring and reporting the transmission delay of the packet transmitted on each logic channel

When the granularity of the measurement and reporting is the whole WLAN network, the measurement and reporting refer to measuring and reporting the transmission delays of all the packets transmitted in the whole second network.

When the granularity of the measurement and reporting is the terminal, the measurement and reporting refer to measuring and reporting the transmission delay of a packet transmitted by a certain terminal, herein the terminal may be a user equipment (UE).

When the granularity of the measurement and reporting is the carrier or serving cell, the measurement and reporting refer to measuring and reporting the transmission delay of a packet transmitted on the specific carrier or serving cell.

In an embodiment, in the embodiment of the present disclosure, the measurement result sent by the terminal to the 3GPP access network is higher in priority than ordinary user plane data.

In an embodiment, when the delay reporting triggering condition is unsatisfied but the ordinary user plane data are less than the currently transportable data size, the terminal utilizes the residual bits to transmit the measurement result information.

### Embodiment VI

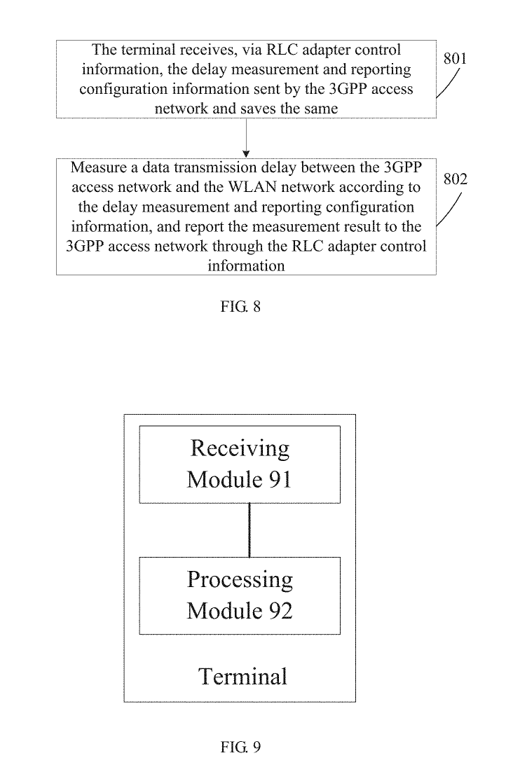

FIG. 9 is a schematic structural diagram showing composition of a terminal according to an embodiment of the present disclosure. As shown in FIG. 9, the terminal according to the embodiment of the present disclosure includes: a receiving module 91 and a processing module 92.

The receiving module 91 is configured to receive delay measurement and reporting configuration information sent by a first network side.

The processing module 92 is configure to measure a data transmission delay between the first network and a second network according to the delay measurement and reporting configuration information, and report a measurement result to the first network side.

The first network may be a 3GPP access network, which not only is applicable to an LTE system but also is applicable to a UMTS system. The second network may be a WLAN network.

In an embodiment, the receiving module 91 receives delay measurement and reporting configuration information sent by the first network side, which includes:

receiving, by the receiving module 91 via RRC signaling, delay measurement and reporting configuration information sent by the first network side; or

receiving, via PDCP control information, the delay measurement and reporting configuration information sent by the first network side; or

receiving, via RLC control information, the delay measurement and reporting configuration information sent by the first network side; or

receiving, via MAC control information, the delay measurement and reporting configuration information sent by the first network side; or

receiving, via second network adaptation layer control information, the delay measurement and reporting configuration information sent by the first network side.

In an embodiment, the receiving module 91 is further configured to save the delay measurement and reporting configuration information. The delay reporting type includes: periodical reporting, event triggering reporting and so on.

In an embodiment, the delay measurement and reporting configuration information includes one or more:

a delay measurement starting condition, a delay measurement stopping condition, a delay reporting type, a delay reporting triggering condition, a logic channel required for delay measurement, and a second network type required for delay measurement.

The delay measurement starting condition may refer to receiving the delay measurement and reporting configuration information sent by the first network side.

The delay measurement stopping condition may refer to a preset measurement timer overtime. Correspondingly, the processing module 92 is further configured to start the preset measurement timer.

When the delay reporting type is the event triggering reporting, the delay reporting triggering condition may be one or more of:

an average delay of data transmission between the first network and the second network within a period of time exceeding a preset first threshold, a proportion of packets whose delay exceeds a preset delay threshold within a period of time exceeding a preset second threshold, a proportion of the number of data bits whose delay exceeds a preset delay threshold within a period of time exceeding a preset third threshold, an average delay of data transmission between the first network and the second network within a period of time being below a preset fourth threshold, a proportion of packets whose delay exceeds a preset delay threshold within a period of time being below a preset fifth threshold, and a proportion of the number of data bits whose delay exceeds a preset delay threshold within a period of time being below a preset sixth threshold.

Herein, the period of time may be set according to actual situations, which may be equal to or smaller than the measurement time, or may be appointed by a protocol, or may be configured in the delay measurement and reporting configuration information. The measurement time is time between starting the measurement timer and the measurement timer overtime.

When the delay reporting type is the periodical reporting, the delay measurement and reporting configuration information may further include a measurement period. The delay reporting triggering condition may refer to a preset measurement timer overtime. That is, the measurement result is reported when the measurement timer is overtime, then the timer is reset to zero and restarts timing and delay measurement, and the measurement result is reported when the measurement timer is overtime again.

In an embodiment, when the delay reporting type is the periodical reporting, the measurement timer starting condition/stopping condition may be one or more of:

an average delay of data transmission between the first network and the second network within a period of time exceeding a preset first threshold, a proportion of packets whose delay exceeds a preset delay threshold within a period of time exceeding a preset second threshold, a proportion of the number of data bits whose delay exceeds a preset delay threshold within a period of time exceeding a preset third threshold, an average delay of data transmission between the first network and the second network within a period of time being below a preset fourth threshold, a proportion of packets whose delay exceeds a preset delay threshold within a period of time being below a preset fifth threshold, and a proportion of the number of data bits whose delay exceeds a preset delay threshold within a period of time being below a preset sixth threshold.

Herein, when the delay reporting type is the periodical reporting, the period of time may be measurement time, the length of which may be set according to actual circumstances.

In an embodiment, the processing module 92 measures a data transmission delay between a first network and a second network according to the delay measurement and reporting configuration information includes:

decoding, by the processing module 92, a packet transmitted in the second network according to the delay measurement and reporting configuration information to obtain a first timestamp packaged at the first network side and acquire a second timestamp of a current serving cell, and calculating a differential between the first timestamp and the second timestamp and determining the differential as a transmission delay of the packet.

In an embodiment, the processing module 92 is further configured to acquire transmission delays of a plurality of packets transmitted in the second network within measurement time and calculate an average value of the transmission delays, wherein the average value of the transmission delays is an average delay of data transmission between the first network and the second network within the measurement time.

Herein, the packet is a protocol data unit (PDU). When a service data unit (SDU) of the terminal is packaged into the packet at the first network side, current first network system time (namely, the first timestamp) is added into the packet header. Correspondingly, the first timestamp is obtained when the processing module 92 decodes the packet to obtain the SDU.

In an embodiment, the measurement result includes one or more of: an average delay of data transmission between the first network and the second network within a period of time, a proportion of packets whose delay exceeds a preset delay threshold within a period of time, a proportion of the number of data bits whose delay exceeds a preset delay threshold within a period of time, a maximum value of data transmission delay between the first network and the second network within a period of time, and a real-time data transmission delay between the first network and the second network.

Herein the period of time may be set according to actual circumstances, which may be equal to or smaller than the measurement time.

When the period of time is equal to the measurement time, the average delay of data transmission between the first network and the second network within the period of time is the average value of the transmission delays of a plurality of packets transmitted in the second network within the measurement time.

When the period of time is equal to the measurement time, the proportion of packets whose delay exceeds a preset delay threshold within the period of time is a ratio of the number of packets whose transmission delay in the second network within the measurement time exceeds the preset delay threshold to the total number of packets transmitted in the second network within the measurement time.

When the period of time is equal to the measurement time, the proportion of the number of data bits whose delay exceeds a preset delay threshold within the period of time is a ratio of the number of data bits whose transmission delay in the second network exceeds the preset delay threshold within the measurement time to the total number of data bits transmitted in the second network within the measurement time.

When the period of time is equal to the measurement time, the maximum value of data transmission delay between the first network and the second network within the period of time is the maximum value of the transmission delays of a plurality of packets transmitted in the second network within the measurement time.

The real-time data transmission delay between the first network and the second network is the transmission delay of the packet transmitted in the second network obtained based on current measurement.

In an embodiment, reporting, by the processing module 92, a measurement result to the first network side includes:

reporting, by the processing module 92, the measurement result to the first network side via the RRC signaling in the first network; or

reporting the measurement result to the first network side via the PDCP layer control information; or

reporting the measurement result to the first network side via the RLC layer control information; or

reporting the measurement result to the first network side via the MAC layer control information; or

reporting the measurement result to the first network side via the second network adaptation layer.

In an embodiment, granularity of the measurement and reporting may be a combination of one or more of a single logic channel, the whole second network, the terminal, and a carrier/serving cell.

When the granularity of the measurement and reporting is the single logic channel, the measurement and reporting refer to measuring and reporting the transmission delay of the packet transmitted on each logic channel

When the granularity of the measurement and reporting is the whole second network, the measurement and reporting refer to measuring and reporting the transmission delays of all the packets transmitted in the whole second network.

When the granularity of the measurement and reporting is the terminal, the measurement and reporting refer to measuring and reporting the transmission delay of a packet transmitted by a certain terminal, herein the terminal may be a user equipment (UE).

When the granularity of the measurement and reporting is the carrier or serving cell, the measurement and reporting refer to measuring and reporting the transmission delay of a packet transmitted on the specific carrier or serving cell.

In an embodiment, when the delay reporting type is the periodical reporting, the terminal not only may immediately perform the measurement and reporting after receiving the delay measurement and reporting configuration information, but also may perform the measurement and reporting when the measurement timer is reset to zero and starts timing after receiving the delay measurement and reporting configuration information.

In an embodiment, when the delay reporting type is the event triggering reporting, the measurement result sent by the terminal to the first network side is higher in priority than ordinary user plane data.

In an embodiment, when the delay reporting triggering condition is unsatisfied, namely when the currently configured event is not triggered or a configured periodical reporting period is not reached but the ordinary user plane data are less than the currently transportable data size, the terminal utilizes the residual bits to transmit the measurement result information.

The receiving module and the processing module mentioned in the embodiments of the present disclosure may be implemented by a processor, or of course may be implemented by a specific logic circuit. In practical application, the processor may be a central processing unit (CPU), a microprocessor unit (MPU), or a field programmable gate array (FPGA), etc.

In the embodiments of the present disclosure, the method for measuring and reporting a data transmission delay may be stored in a computer-readable storage medium if the method is implemented in the form of software function modules and is sold or used as independent products. Based on such an understanding, the technical solutions of the embodiments of the present disclosure in essence or that part of contribution to the prior art may be embodied in the form of software products, which may be stored in a storage medium, comprising some instructions to cause a computer device (a personal computer, a server or a network device and so on) to execute all or a part of the method as recited in the embodiments of the present disclosure. The aforementioned storage medium includes: a USB flash disk, a mobile hard disk, a read only memory (ROM), a magnetic disk or an optical disk and other media capable of storing program codes. Thus, the present disclosure is not limited to combination of hardware and software in any particular form.

Correspondingly, an embodiment of the present disclosure further provides a computer storage medium, the computer storage medium stores a computer program, which is configured to execute the method for measuring and reporting a data transmission delay according to the embodiments of the present disclosure.

The above are merely preferred embodiments of the present disclosure, and are not intended to limit the scope of protection of the present disclosure.

1. A method for measuring and reporting a data transmission delay, comprising:
receiving, by a terminal, delay measurement and reporting configuration information sent by a first network side; and
measuring a data transmission delay between a first network and a second network according to the delay measurement and reporting configuration information, and reporting a measurement result to the first network side.

2. The method according to claim 1, wherein the receiving, by a terminal, delay measurement and reporting configuration information sent by a first network side comprises:
receiving, by the terminal via a radio resource control (RRC) signaling, the delay measurement and reporting configuration information sent by the first network side; or
receiving, by the terminal via packet data convergence protocol (PDCP) control information, the delay measurement and reporting configuration information sent by the first network side; or
receiving, by the terminal via radio link control (RLC) protocol control information, the delay measurement and reporting configuration information sent by the first network side; or
receiving, by the terminal via media access control (MAC) control information, the delay measurement and reporting configuration information sent by the first network side; or
receiving, by the terminal via second network adaptation layer control information, the delay measurement and reporting configuration information sent by the first network side.

3. The method according to claim 1, wherein the delay measurement and reporting configuration information comprises one or more of:
a delay measurement starting condition, a delay measurement stopping condition, a delay reporting type, a delay reporting triggering condition, a logic channel required for delay measurement, and a second network type required for delay measurement.

4. The method according to claim 1, wherein the measuring a data transmission delay between a first network and a second network according to the delay measurement and reporting configuration information comprises:
decoding a packet transmitted in the second network according to the delay measurement and reporting configuration information to obtain a first timestamp packaged at the first network side and acquire a second timestamp of a current first network serving cell, and calculating a differential between the first timestamp and the second timestamp and determining the differential as a transmission delay of the packet.

5. The method according to claim 4, further comprising:
acquiring transmission delays of a plurality of packets transmitted in the second network within measurement time and calculating an average value of the transmission delays, the average value of the transmission delays being an average delay of data transmission between the first network and the second network within the measurement time.

6. The method according to claim 1, wherein the measurement result comprises one or more of: an average delay of data transmission between the first network and the second network within a period of time, a proportion of packets whose delay exceeds a preset delay threshold within a period of time, a proportion of the number of data bits whose delay exceeds a preset delay threshold within a period of time, a maximum value of data transmission delay between the first network and the second network within a period of time, and a real-time data transmission delay between the first network and the second network.

7. The method according to claim 1, wherein the reporting a measurement result to the first network side comprises:
reporting the measurement result to the first network side via the RRC signaling; or
reporting the measurement result to the first network side via the PDCP layer control information; or
reporting the measurement result to the first network side via the RLC layer control information; or
reporting the measurement result to the first network side via the MAC layer control information; or
reporting the measurement result to the first network side via the second network adaptation layer.

8. The method according to claim 3, wherein the delay reporting triggering condition comprises one or more of:
timer periodical triggering, an average delay of data transmission between the first network and the second network within a period of time exceeding a preset first threshold, a proportion of packets whose delay exceeds a preset delay threshold within a period of time exceeding a preset second threshold, a proportion of the number of data bits whose delay exceeds a preset delay threshold within a period of time exceeding a preset third threshold, an average delay of data transmission between the first network and the second network within a period of time being below a preset fourth threshold, a proportion of packets whose delay exceeds a preset delay threshold within a period of time being below a preset fifth threshold, and a proportion of the number of data bits whose delay exceeds a preset delay threshold within a period of time being below a preset sixth threshold.

9-16. (canceled)

17. A terminal, comprising:
a processor; and
a memory configured to store instructions executable by the processor;
wherein the processor is configured to perform:
receiving delay measurement and reporting configuration information sent by a first network side; and
measuring a data transmission delay between a first network and a second network according to the delay measurement and reporting configuration information, and reporting a measurement result to the first network side.

18. The terminal according to claim 17, wherein the processor configured to perform receiving, by a terminal, delay measurement and reporting configuration information sent by a first network side is configured to perform:
receiving via a radio resource control (RRC) signaling, the delay measurement and reporting configuration information sent by the first network side; or
receiving via packet data convergence protocol (PDCP) control information, the delay measurement and reporting configuration information sent by the first network side; or
receiving via radio link control (RLC) protocol control information, the delay measurement and reporting configuration information sent by the first network side; or
receiving via media access control (MAC) control information, the delay measurement and reporting configuration information sent by the first network side; or
receiving via second network adaptation layer control information, the delay measurement and reporting configuration information sent by the first network side.

19. The terminal according to claim 17, wherein the delay measurement and reporting configuration information comprises one or more of:
a delay measurement starting condition, a delay measurement stopping condition, a delay reporting type, a delay reporting triggering condition, a logic channel required for delay measurement, and a second network type required for delay measurement.

20. The terminal according to claim 17, wherein the processor configured to perform measuring a data transmission delay between a first network and a second network according to the delay measurement and reporting configuration information is configured to perform:
decoding a packet transmitted in the second network according to the delay measurement and reporting configuration information to obtain a first timestamp packaged at the first network side and acquire a second timestamp of a current first network serving cell, and calculating a differential between the first timestamp and the second timestamp and determining the differential as a transmission delay of the packet.

21. The terminal according to claim 20, the processor is further configured to perform:
acquiring transmission delays of a plurality of packets transmitted in the second network within measurement time and calculating an average value of the transmission delays, the average value of the transmission delays being an average delay of data transmission between the first network and the second network within the measurement time.

22. The terminal according to claim 17, wherein the measurement result comprises one or more of: an average delay of data transmission between the first network and the second network within a period of time, a proportion of packets whose delay exceeds a preset delay threshold within a period of time, a proportion of the number of data bits whose delay exceeds a preset delay threshold within a period of time, a maximum value of data transmission delay between the first network and the second network within a period of time, and a real-time data transmission delay between the first network and the second network.

23. The terminal according to claim 17, wherein the processor configured to perform reporting a measurement result to the first network side is configured to perform:
reporting the measurement result to the first network side via the RRC signaling; or
reporting the measurement result to the first network side via the PDCP layer control information; or
reporting the measurement result to the first network side via the RLC layer control information; or
reporting the measurement result to the first network side via the MAC layer control information; or
reporting the measurement result to the first network side via the second network adaptation layer.

24. The terminal according to claim 19, wherein the delay reporting triggering condition comprises one or more of:
timer periodical triggering, an average delay of data transmission between the first network and the second network within a period of time exceeding a preset first threshold, a proportion of packets whose delay exceeds a preset delay threshold within a period of time exceeding a preset second threshold, a proportion of the number of data bits whose delay exceeds a preset delay threshold within a period of time exceeding a preset third threshold, an average delay of data transmission between the first network and the second network within a period of time being below a preset fourth threshold, a proportion of packets whose delay exceeds a preset delay threshold within a period of time being below a preset fifth threshold, and a proportion of the number of data bits whose delay exceeds a preset delay threshold within a period of time being below a preset sixth threshold.

25. A non-transitory computer-readable storage medium having stored therein instructions that, when executed by a processor of a terminal, causes the terminal to perform a method for measuring and reporting a data transmission delay, the method comprising:
receiving delay measurement and reporting configuration information sent by a first network side; and
measuring a data transmission delay between a first network and a second network according to the delay measurement and reporting configuration information, and reporting a measurement result to the first network side.
